(19) United States
(12) Patent Application Publication
(10) Pub. No.: US 2015/0206192 A1
(43) Pub. Date: Jul. 23, 2015

(54) INCREASING RELIABILITY AND EFFICIENCY OF MATCHING ITEMS BASED ON ITEM LOCATIONS AND GEO-LOCATION SETTINGS

(71) Applicant: KBR IP Holdings, LLC, Provo, UT (US)

(72) Inventors: Nathaniel Brent Kranendonk, Springville, UT (US); Brett Leon Ross, Salt Lake City, UT (US)

(21) Appl. No.: 14/601,178

(22) Filed: Jan. 20, 2015

Related U.S. Application Data
(60) Provisional application No. 61/929,658, filed on Jan. 21, 2014.

(51) Int. Cl. G06Q 30/02

(52) U.S. Cl. CPC G06Q 30/0269

(57) ABSTRACT

The present invention extends to methods, systems, and computer program products for increasing the efficiency and reliability of matching items based on item locations and geo-location settings. Items can be matched based on location and geo-location settings as well as a number of other characteristics, such as, for example, individual interests. Using locations and geo-location settings in addition to the other characteristics permits social media sites to more efficiently and reliably match a social media user to activities that are more likely to be relevant to the social media user. Both computer system (e.g., processor and memory) resources and network (e.g., bandwidth) resources are conserved by more efficiently and reliably matching a social media user to relevant activities.

### CROSS-REFERENCE TO RELATED APPLICATIONS

This application claims the benefit of and priority to U.S. Provisional Patent Application Ser. No. 61/929,658, entitled “Geo-Located Social Connectivity Relating To Commerce Partners”, filed Jan. 21, 2014 by Nathaniel Brent Kranendonk et al., the entire contents of which are expressly incorporated by reference.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

For example, computer networks are frequently used for social networking. Multiple users can access social networking Web sites on the Internet to share information with one another, play games, access news, view deals, schedule meetings, etc. However, most, if not all, social networking sites target a single or limited subset of social networking functionalities. Some sites exist to bring people together to converse, post ideas, interact in forums and share life memories through pictures, etc. (i.e., provide social functionality). Other sites exist to schedule meetings, events and special occasions (i.e., provide event functionality). Further sites exist that target potential end users of ads, promotions and deals (i.e., provide deal functionality).

Additionally, most, it not all, social media sites lack the ability to efficiently and reliably group similar like-minded individuals in an actionable, real-world event with commerce/retail opportunities targeted to the group based on past behavior and purchase patterns. A user and/or a commerce partner can consume computer system and network resources attempting to identify matching opportunities. Possible matching opportunities can be narrowed down through trial and error communication between a user's client device and a social network site's server's (e.g., submitting a search, refining search terms to narrow results, submitting a further search, etc.).

Social media sites also typically lack any mechanism to refine possible matching opportunities based on current user location relative to opportunity location (and possibly also considering time constraints). Thus, social media sites can present opportunities to a social media user that are physically located so far away from the user it is unlikely the user would desire to attend or it is impractical for the user to attend even if they desired to attend. The social media user can consume computer system and network resources wading through these potentially matching opportunities trying to find relevant opportunities.

For example, a social media user located in Chicago, Ill. may be highly interested in shoes. However, it is unlikely and/or may be impractical for the social media user to attend a one day sale at retail show shop in Miami, Fla. if the user is made aware of the one day sale on the day of the one day sale. None the less, based on the interest in shoes, a social media site may return the one day sale as an event of interest to the social media user. At the least, the social media user may have to view and ignore the opportunity. If too many of these type or similar opportunities are returned in results, the social media user may have to send a new more restrictive query (thereby consuming additional computer system and network bandwidth resources) to reduce the results.

Similar resource consumption patterns can also occur when presenting coupons and other offers to social media users that require in-person attendance at a particular location.

### BRIEF SUMMARY

The present invention extends to methods, systems, and computer program products for increasing the efficiency and reliability of matching items based on item locations and geo-location settings. Items representing individuals can be matched to items representing activities of interest to the individuals (or vice versa) taking into account the current location of and/or geo-location settings for the individuals and the current location and/or geo-location settings of the activities. In one aspect, an intelligent interactive tool (e.g., available through a social media website user-interface) provides individuals and commerce partners the ability to geo-locate like-minded individuals/groups and participate in events. Commerce partners can generate activities including events, promotions, and deals, as well as build followings, relationships, and communities.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates matching an item representing a person to an item representing an activity.

FIG. 2 illustrates a flow chart of an example method for matching an item representing a person to an item representing an activity.

FIG. 3 illustrates an example computer architecture that facilitates matching an item representing an activity to one or more person items representing a corresponding one or more persons.

FIG. 4 illustrates a flow chart of an example method for matching an item representing an activity to one or more person items representing a corresponding one or more persons.

FIG. 5 illustrates an example computer architecture that facilitates geo-located social connectivity relating to commerce partners.

### DETAILED DESCRIPTION

The present invention extends to methods, systems, and computer program products for increasing the efficiency and reliability of matching items based on item locations and geo-location settings. Items representing individuals can be matched to items representing activities of interest to the individuals taking into account the current location of and geo-location settings for the individuals and the current location of the activities. In one aspect, items are matched based on location and geo-location settings as well as a number of other characteristics, such as, for example, individual interests.

Using locations and geo-location settings in addition to the other characteristics permits a social media site to more efficiently and reliably match a social media user to activities that are more likely to be relevant to the social media user. Social media user can be matched to relevant activities with less manual refinement by the social media user. For example, a social media user can identify relevant activities with fewer queries, searches, etc., submitted from their client device to the social media servers. Accordingly, both computer system (e.g., processor and memory) and network (e.g., bandwidth) resources are conserved by more efficiently and reliably matching a social media user to relevant activities.

In one aspect, activities are provided by commerce partners of a social media site. The provided activities can have various characteristics including a location. As such, an intelligent interactive tool (e.g., available through a social media website user-interface) can provide individuals and commerce partners the ability to geo-locate like-minded individuals/groups and participate in activities. For example, commerce partners can generate events, promotions, and deals as well as build followings, relationships, and communities.

In another aspect, a social media site server matches relevant activities to one or more social media users based on locations and geo-location settings prior to a query for relevant activities from the one or more social media users. That is, the social media site server pre-matches social media users to relevant activities based on locations and geo-location settings. The determined relevant activities can be cached and returned to the one or more users in response to subsequently received queries. It may be that pre-matching is performed during times of reduced utilization of social media site resources. Caching relevant activities and returning cached relevant activities more appropriately balances resources usage between times of higher and lower resource utilization at a social media site.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

Aspects of the invention provide intelligent interactive tools for individuals to geo-locate like-minded individuals/groups, participate in events (self-generated or by others/businesses), with local and national businesses supporting the events through advertising promotions, and deals. The interactive tools can be utilized to more efficiently and reliably identify activities that are relevant to a social media user. Efficient and reliable identification of relevant activities reduces network communication between social media user client devices and social media site servers and conserves resources at both client devices and social media site servers.

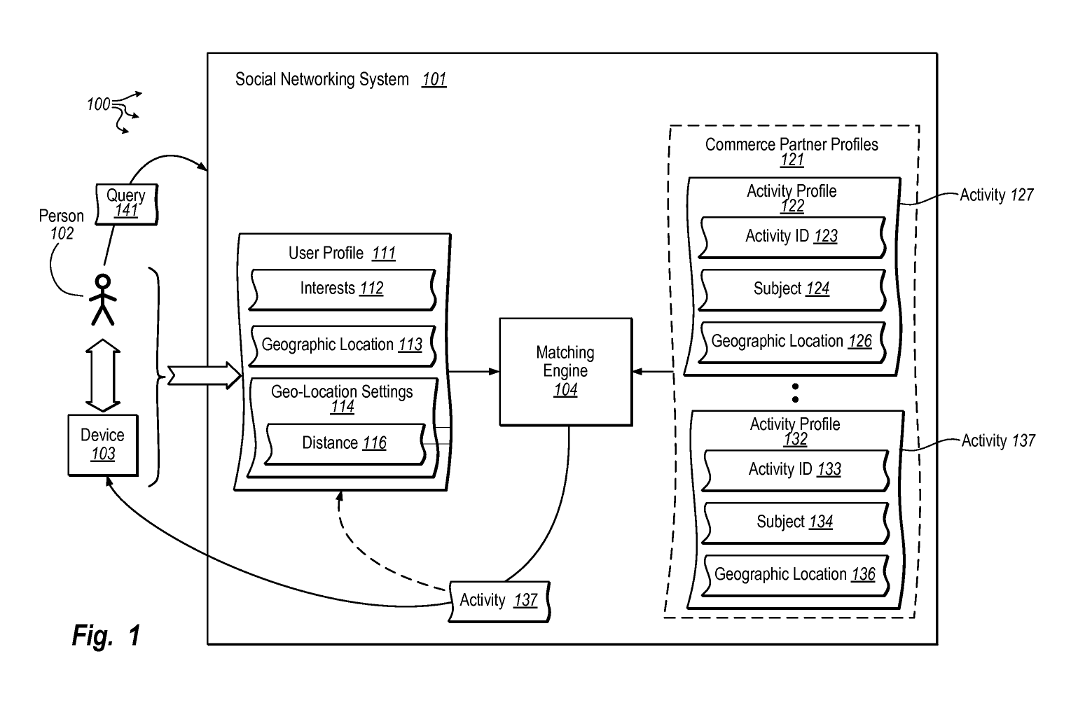

FIG. 1 illustrates an example computer architecture 100 that facilitates matching an item representing a person to an item representing an activity. Referring to FIG. 1, computer architecture 100 includes social networking system 101 and device 103. Each of social networking system 101 and device 103 can be connected to one another over (or be part of) a network, such as, for example, a Local Area Network (“LAN”), a Wide Area Network (“WAN”), and even the Internet. Accordingly, social networking system 101 and device 103 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

Social networking system 101 includes matching engine 104. Matching engine 104 can be used to match a person to an activity, such as, for example, an event or deal. Matching can be facilitated by one or more of: geographic location, geo-location setting, and user interests.

Person 102 can use device 103 to connect to social networking system 101. For example, person 102 can be a user of social networking system 101. Accordingly, person 102 can create and maintain a user profile (e.g., user profile 111). Thus, user profile 111 is an item representing person 102 on social networking system 101. Other users of social networking system 101 can also create and maintain corresponding user profiles. A user profile can contain elements representing essentially any information about a user, such as, for example, the user's interests, the user's geographic location, the user's geo-location settings, the user's age, the user's gender, the user's sexual orientation, the user's religion, the user's race, the user's school, etc. Social networking system 101 can have hundreds, thousands, or even millions of users and thus hundreds, thousands, or even millions of corresponding user profiles.

Geo-location settings can include a specified distance. The user may desire to be made aware of activities that are closer than the specified distance to the user. The user may desire to not be made aware of activities that are further than the specified distance from the user. In some embodiments, a specified distance is a radius around the user, such as, for example, 100 yds, a ½ mile, a mile, etc. A user may desire to be made aware of activities with the radius.

In other aspects, the specified distance can represent a general geographic area, such as, for example, a zip code. The zip code may or may not be where the user is geographically located. For example, if concerts are frequently held within a zip code, a user may desire to be made aware of activities in the zip code even when the user is not physically present within the zip code.

A user's device (e.g., device 103) can update a geographic location for the user (person 102) as the user moves. For example, a mobile phone can use Global Positioning System (“GPS”) coordinates to determine a user's location and automatically update the user's profile with the user's geographic location.

Commerce partners of social networking system 101 can also create activity profiles for activities. The profiles can be maintained in commerce partner profiles 121. An activity can be an event (e.g., concerts, conventions, public events, sporting event, etc.) or deal (e.g., advertisements, coupons, promotions, etc.). An activity profile can include an activity identifier (e.g., a name), an activity subject or topic (which can be used to align with users' interests), a geographic location, geo-location settings, a date, a time, an activity description, etc.

For example, one or more commerce partners of social networking system 101 can create activity profiles 122 and 132. An activity profile can include can include an activity ID (e.g., an activity name), an activity subject, and a geographic location. For example, activity profile 122 and activity profile 132 include activity IDs 123 and 133 respectively, subjects 124 and 134 respectively, and geographic locations 126 and 136 respectively. When an activity is of limited duration, an activity profile can also include a date and time when the activity is to occur or end or when the activity is occurring or ending.

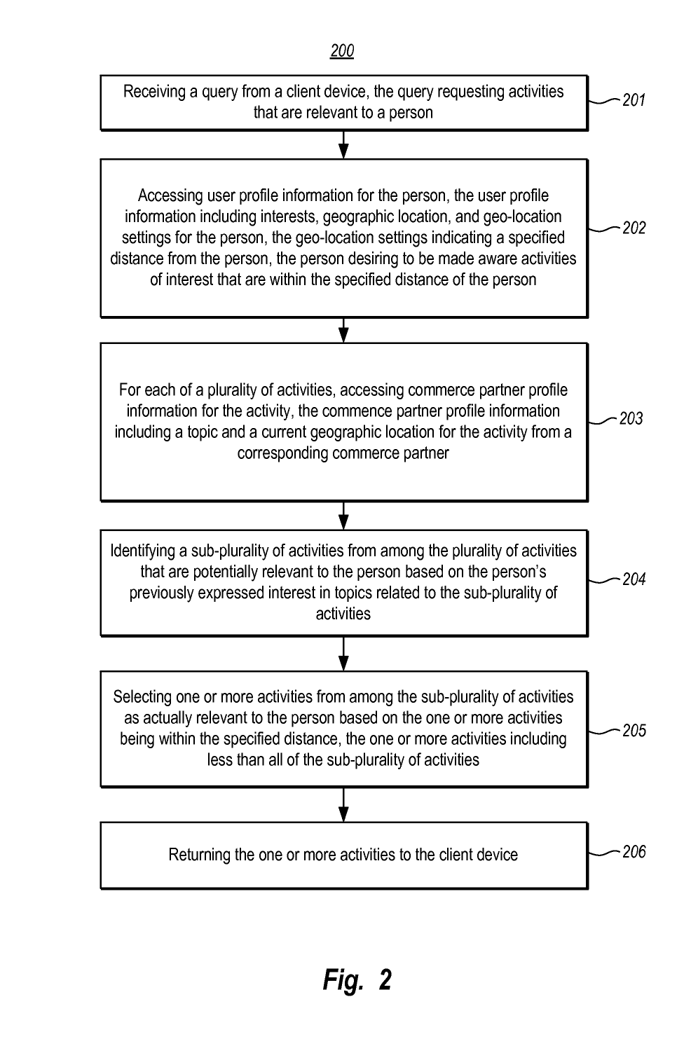

FIG. 2 illustrates a flow chart of an example method 200 for matching an item representing a person to an item representing an activity. Method 200 will be described with respect to the components and data of computer architecture 100.

Method 200 includes receiving a query from a client device, the query requesting activities that are relevant to the person (201). For example, person 102 can operate device 103 to cause device 103 to submit query 141 to social networking system 101. Social networking system 101 can receive query 141 from device 103. Query 141 can be a request for activities that are relevant to user 102

Method 200 includes accessing user profile information for the person, the user profile information including interests, current geographic location, and geo-location settings for the person, the geo-location settings indicating a specified distance from the person, the person desiring to be made aware of activities of interest to the person that are within the specified distance of the person (202). For example, matching engine 104 can access user profile 111 for person 102. As depicted, user profile 111 includes interests 112, geographic location 113, and geo-location settings 114. Geo-location settings 114 further include distance 116. Based on the information in user profile 111, matching engine 104 can determine that person 102 desires to be made aware of activities within distance 116 of geographic location 113 and that are relevant to interests 112. Interests 112 can be previously indicated through an interface to social networking system 101. Interests 112 can include various different interests, such as, for example, music, movies, technology, meeting other people, politics, sports, etc.

Method 200 includes for each of a plurality of activities, accessing commerce partner profile information for the activity, the commerce partner profile information including a topic and a current geographic location for the activity from a corresponding commerce partner (203). For example, matching engine 104 can access commerce partner profiles 121. Commerce partner profiles 121 can include activity profiles for a plurality of different events. As depicted, activity profiles 121 include activity profile 122 for activity 127, activity profile 132 for activity 137, etc.

Each activity profile in commerce partner profiles 121 can include an activity ID (e.g., an activity name), an activity subject, and a geographic location. For example, activity profile 122 and activity profile 132 include activity IDs 123 and 133 respectively, subjects 123 and 124 respectively, and geographic locations 126 and 136 respectively. Subjects can relate to various differ subjects including music, movies, technology, meeting other people, politics, sports, etc. When an activity is of limited duration, an activity profile can also include a date and time when the activity is to occur or is occurring.

Method 200 includes identifying sub-plurality of activities from among the plurality of activities that are potentially relevant to the person based on the person's previously expressed interest in topics related to the sub-plurality of activities (204). For example, matching engine 104 can identify activities 127 and 137 as potentially relevant to person 102 based on a comparison of interests 112 to subjects 124 and 126.

Method 300 includes selecting one or more activities from among the sub-plurality of activities as actually relevant to the person based on the one or more activities being within the specified distance, the one or more activities including less than all of the sub-plurality of activities (205). For example, matching engine 104 can select activity 137 as actually relevant to person 102 based on geographic location 136 being within specified distance 116 of geographic location 113. Matching engine 104 can determine that is not actually relevant activity 127 based on geographic location 126 being further than specified distance 116 from geographic location 113

Method 200 includes returning the one or more activities to the client device (206). For example, matching engine 104 can return activity 137 to device 103 and/or store activity 137 in user profile 111 for output to person 102.

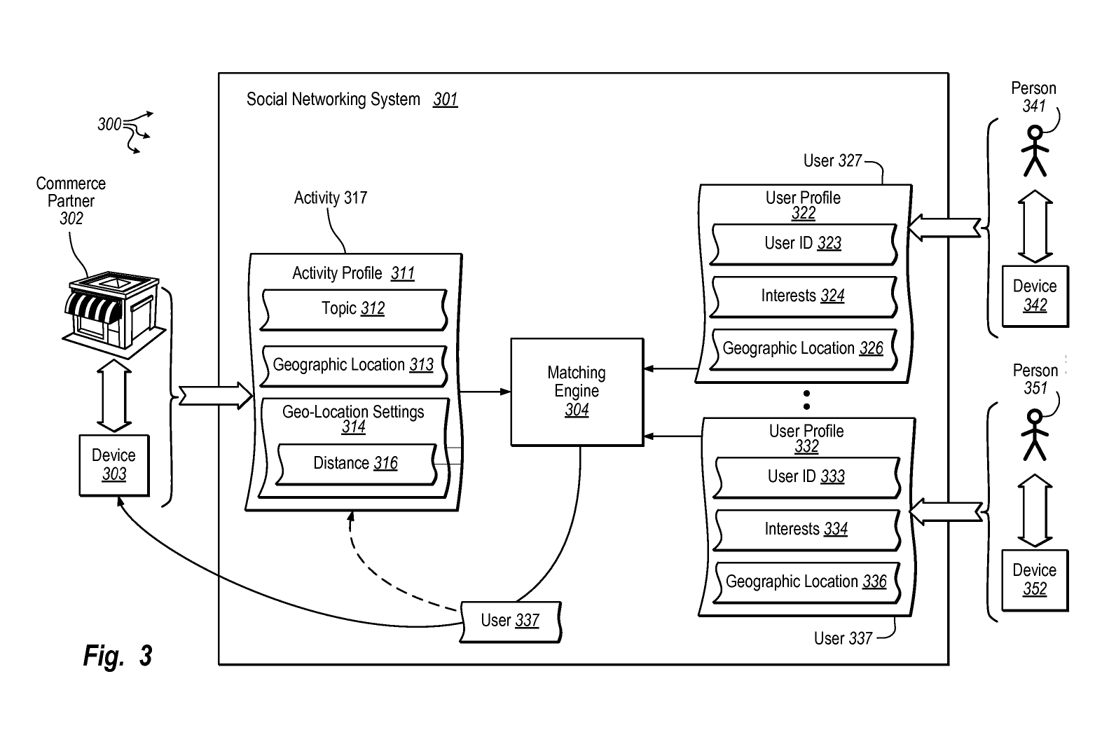

FIG. 3 illustrates an example computer architecture 300 that facilitates matching an item representing an activity to one or more person items representing a corresponding one or more persons. Referring to FIG. 3, computer architecture 300 includes social networking system 301 and devices 303, 342, and 352. Each of social networking system 301 and devices 303, 342, and 352 can be connected to one another over (or be part of) a network, such as, for example, a Local Area Network (“LAN”), a Wide Area Network (“WAN”), and even the Internet. Accordingly, social networking system 301 and devices 303, 342, and 352 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

Social networking system 301 includes matching engine 304. Matching engine 304 can be used to match an event to people viewing the event as relevant. Matching can be facilitated by profile elements including one or more of: an event topic, geographic locations, geo-location settings, and user interests.

Commerce partners and people can use computing devices to connect to social networking system 301. For example, commerce partner 302 and people 341 and 351 can use devices 303, 342, and 352 respectively to connect to social networking system 301. Each of commerce partner 302 and people 341 and 351 can be a user of social networking system 301. Each user of social networking system 301 (including commerce partners and people) can have a user profile. As such, persons 341 and 351 can create and maintain user profiles 322 and 332 respectively on social networking system 301.

Other users of social networking system 301 can also create and maintain corresponding user profiles. As described, a user profile can contain elements representing essentially any information about a user, such as, for example, the user's interests, the user's geographic location, the user's geo-location settings, the user's age, the user's gender, the user's sexual orientation, the user's religion, the user's race, the user's school, etc. Thus, each user profile can include a user ID (e.g., a user name), the user's interests, and the user's (e.g., last known) geographic location. For example, user profile 322 indicates user ID 323, interests 324, and geographic location 326 for user 327 (i.e., person 341). Similarly, user profile 332 indicates user ID 333, interests 334, and geographic location 336 for user 327 (i.e., person 341)

Social networking system 301 can have hundreds, thousands, or even millions of user and thus hundreds, thousands, or even millions of corresponding user profiles.

Also as described, a user's device (e.g., device 342, 352) can update a geographic location for the user (e.g., person 341, 351) as the user moves. For example, a mobile phone can use Global Positioning System (“GPS”) coordinates to determine a user's location and automatically update the user's profile with the user's geographic location.

Similarly, commence partner 302 can have a commerce partner profile. A commence partner profile can include business information, indicate goods and services provided, location information (both physical and digital), etc. Social networking system 301 can have hundreds, thousands, or even millions of user and thus hundreds, thousands, or even millions of corresponding commerce partner profiles.

Commerce partners can also indicate activities (e.g., sale, promo, deals, etc.) they are holding. Activities can have activity profiles, including a topic, geographic location, and geo-location settings. Geo-locations settings can further include a distance. For example, commerce partner 302 can hold activity 317. Commerce partner 302 can submit activity profile 311 to social networking system 101 indicating information about activity 317. As depicted, activity profile 311 includes topic 312 (e.g., sports, movies, books, music, etc.), geographic location 313, and geo-location settings 314. Geo-location settings 314 further include distance 316. Based on the information in activity profile 311 and user profiles, matching engine 304 can determine persons to which activity 317 is relevant.

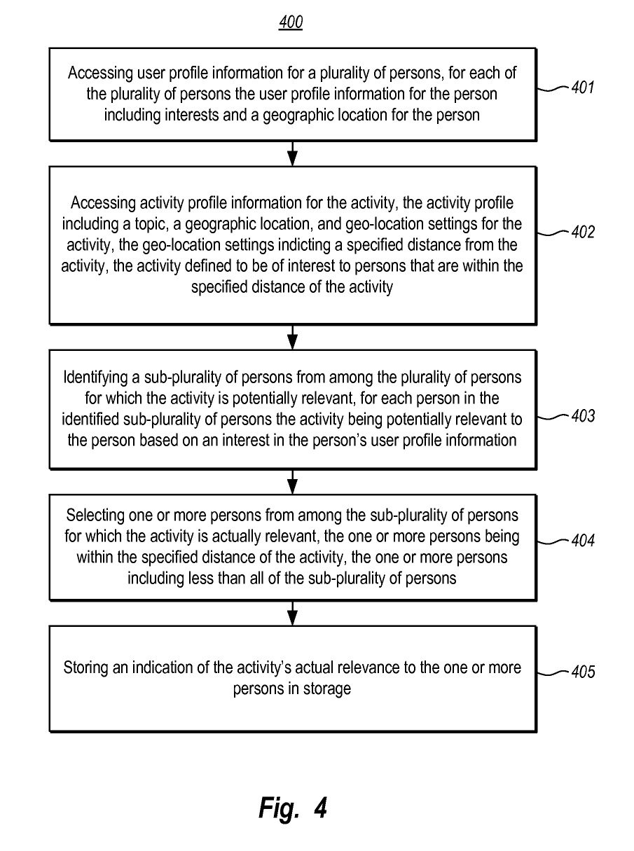

FIG. 4 illustrates a flow chart of an example method 400 for matching an item representing an activity to one or more person items representing a corresponding one or more persons. Method 400 will be described with respect to the components and data of computer architecture 300.

Method 400 includes accessing user profile information for the plurality of persons, for each of the plurality of persons the user profile information including interests and a geographic location for the person (401). For example, matching engine 304 can access a plurality of user profiles, including user profiles 322 and 332, for social networking system 301. Each profile can include interests (e.g., interests 324 and 334) and a geographic location (e.g., geographic locations 326 and 336) for a person (e.g., persons 341 and 351).

Method 400 includes accessing activity profile information for the activity, the activity profile information including a topic, a geographic location, and geo-location settings for the activity, the geo-location settings indicating a specified distance from the activity, the activity defined to be of interest to persons that are within the specified distance of the activity (402). For example, matching engine 304 can access activity profile 311 for activity 317. As described, activity profile 311 includes topic 312, geographic location 313, and geo-location settings 314, including distance 316. Based on activity profile 311, matching engine 304 determines that activity 317 is defined to be of interest to people that are within distance 316 of geographic location 313.

Method 400 includes identifying a sub-plurality of persons from among the plurality of persons for which the activity is potentially relevant, for each person in the identified sub-plurality of persons the activity being potentially relevant to the person based on an interest in the person's user profile information (403). For example, matching engine 304 can identify persons 341 and 351 as persons for which activity 317 is potentially relevant. Matching engine 304 can identify persons 341 and 351 by comparing topic 312 to interests 324 and 334. For example, topic 312 may be baseball and interests 324 and 334 can indicate interests in baseball (or more generally in sports).

Method 400 include selecting one or more persons from among the sub-plurality of persons for which the activity is actually relevant, the one or more persons being within the specified distance of the activity, the one or more persons including less than all of the sub-plurality of persons (404). For example, matching engine 304 can select user 337 (person 351) for which activity 317 is actually relevant based on geographic location 336 being within specified distance 316 of geographic location 313. Matching engine 304 can determine that activity 317 is not actually relevant to user 327 (person 341) based on geographic location 326 being further than specified distance 316 from geographic location 313.

Method 400 includes storing an indication of the activity's actual relevance to the one or more persons in storage (405). For example, matching engine 304 can store user 337 to device 303 and/to activity profile 311. The association between user 337 and event 317 can be stored (cached) in disk or to system memory. Thus, if person 351 subsequently queries for relevant activities, event 317 can be identified as relevant with little additional processing.

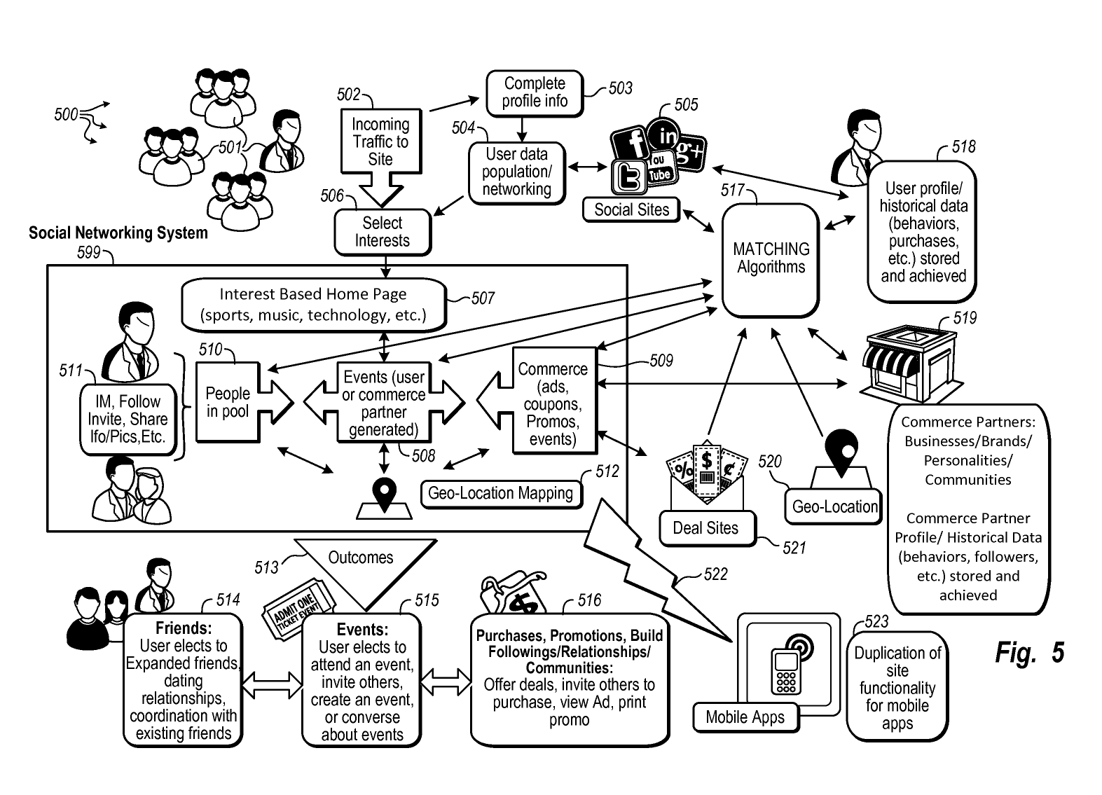

FIG. 5 illustrates an example computer architecture 500 that facilitates geo-located social connectivity relating to commerce partners.

Incoming traffic 502 for users 501 (whether individuals or commerce partners) can enter social networking site 599 through a network, such as, for example, the World Wide Web (“WWW”) or other Internet access. New users can be prompted to complete profile information 503 and have the option 504 to populate their profile information by using log-in information from other social network sites 505. Social networking system 599 is configured to pull profile information from other social network sites 505 in order to populate appropriate data in a profile for social networking system 599. Social networking system 599 can also mine social network sites 505 to access other demographic information, behaviors, etc. for a user.

When profile information is populated, a user can be prompted to select his or her interests 506 from a plurality of options. A user interface can present drill-down user-interface controls to enable the user to fine-tune their sub-interests within more general level of interests. For example, selecting sports can further segment into varying sport interests, such as, basketball, football, etc. Upon completion selecting interests 506, the user is grouped into each of the selected interests and then moves to interest based homepage 507. Interest based homepage 507 can include information in one or more categories each supporting one another with regards to people 511, event 508, and commerce 509.

Commerce 509 can include site-generated deals or affiliate deals promoted on the site from other deal-a-day sites, coupons, promotions, and advertising—from local and/or national businesses. Events 508 are either user or commerce partner created. The event can be categorized by today, 2-3 days and future. People 511 can include individuals that are: a) currently on social networking system 599 and within the people pool 510 or b) selected the people pool 510 as a basic interest. Users can chose to IM, follow, invite to events, share information, photos, and other information with users 511.

People 511, commerce 509, and events 508 can be matched through various matching algorithms 517 designed to match data fields, words, past behaviors, location, predictive future behavior, etc. People 511, commerce 509, and events 508 can be geo-located 512, based on user preferences. The user has any of several outcomes 513 that can result from visiting each of the home pages.

Friends 514: The user can further establish existing friendships through information sharing, event participation or other social behaviors. The user may choose to integrate Events and Deals, but can also use the site and each category to maintain or establish friendships or a variety of purposes. Events 515: The user has the option to post events or browse and participate in others' events. Businesses, can also post events. Purchase 516: The user can choose to browse and purchase deals/ideas, coupons, promotions, and view advertising relating to the category (people, events, deals).

Any of defined and historical user behavior 518, data pulled from social sites 505, businesses site-generated deals, promos and advertising 519, affiliate referral deals 521 can be used by matching algorithms 517 in predictive modeling and matching for future categories.

Geo-location 520 of each category element can be used to enhance the overall user experience. For example, geo-location 520 can be used to significantly increase the relevance of activities (e.g., events and deals) matched to people 511.

Site elements are accessible through wireless exchanges 522, such as, for example, phone and tablets 523.

In some embodiments, a commerce partner creates an activity and then has the ability to choose one or more of: deals, advertisements, and promos relevant to the activity (e.g., as proposed by the site). In other embodiments, a commerce partner creates an activity and then an algorithms predictive behavior is used to assign one or more of: deals, advertisements, and promos to the activity based on one or more of: past behavior, location, and predicted future behavior.

Aspects of the invention can use intelligent specifications, algorithms and matching of defined data criteria to achieve a unique user experience.

Modules, algorithms, components, etc., depicted in computer architecture 500 can be connected to one another over (or be part of) a network, such as, for example, a Local Area Network (“LAN”), a Wide Area Network (“WAN”), and even the Internet. Accordingly, the modules, algorithms, components, etc., depicted in computer architecture 700 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

Aspects of the invention integrate geo-location as a component of matching persons to activities and vice versa. Integrating geo-location functionality provides opportunities for persons to be matching to more relevant activities. The provided opportunities can be further integrated with business-sponsored ads, promotions, or deal-a-day enhancements. In some embodiments, profile elements combined with interests and/or geographic location and geo-location settings are used to match users to marketing events or other people.

Aspects of the invention provide tools for commerce partners (e.g., businesses, brands, personas, communities, causes, etc.) to spread product, brand, service and cause while propelling each into the forefront of existing and potential customers' (other user's) minds Commerce partners can create their own profile to facilitate branding, segmentation, geographic reach, promotions and advertising.

Interested individuals (or commerce partners) can follow and become “favorites” for a commerce partners. When they do so, their friends can be notified. Commerce partners can store and share photos, links, information about the business, calendar of events, promotions, post sand chats. Activity on each commerce partner page can get posted, available and visible for followers or non-followers to see. Communities and Causes can also create commerce partner profiles, targeting existing or new individuals to their efforts.

Embodiments of the invention include algorithms (e.g., matching algorithms 517, enabling commerce partners to target specific demographic groups. Targeting can be based on individuals self-defining their interests (e.g., in their user profile 518) by selection of one or more interests from among a plurality of possible interests. By doing so, individual interests, activities, behaviors and purchasing patterns are grouped within selected interests, and then divided into sub-interests with even more detailed behaviors (e.g., sports could be sub-divided to Basketball, Football, Swimming, etc.). Based on selected interests and sub-interests, commerce partners can target individual users.

By pre-selecting/expressing interests, user's mobile behaviors can then be recognized to target commerce partner activities to the users. For example, as users move around a city, local business can market to those users that have already expressed an interest without the users have to take any further express actions with respect to the local business (e.g., without having to check in). A user can open the website or application and be provided with marketing material that is of interest based on earlier selected interests.

Furthermore, based on past behaviors when interacting with the website or application, algorithms facilitate joining of users with commerce partners through recommendations and introductions, solidifying formative or existing relationships. Additionally, commerce partners can create multiple profiles to best reach their desired demographic. For example, an Artist may be a musician, a movie star, and a Social Pioneer. Three unique profiles, within three different interests (Music, Entertainment, World Mark), enables the artist to promote a different message, profile and brand to existing or new customers.

Accordingly, embodiments of the invention can be used by commerce partners as a portal which enables commerce partners to target existing and new customers. User selected interests better enable commerce partners to segment and target users. Since users pre-select interests, users are relieved form having to “check in”, or proactively seek out business partners. Commerce partners can be targeted to users as users move between geographic locations based on the user's prior selected interests and behaviors. Thus, commerce partners are better enable to find potential customers.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. At a computer system, the computer system including a processor, a method for matching an item representing a person to an item representing an activity, the method comprising a processor:
receiving a query from a client device, the query requesting activities that are relevant to the person;
accessing user profile information for the person, the user profile information including interests, current geographic location, and geo-location settings for the person, the geo-location settings indicating a specified distance from the person, the person desiring to be made aware of activities of interest to the person that are within the specified distance of the person;
for each of a plurality of activities, accessing commerce partner profile information for the activity, the commerce partner profile information including a topic and a current geographic location for the activity from a corresponding commerce partner;
identifying sub-plurality of activities from among the plurality of activities that are potentially relevant to the person based on the person's previously expressed interest in topics related to the sub-plurality of activities;
selecting one or more activities from among the sub-plurality of activities as actually relevant to the person based on the one or more activities being within the specified distance, the one or more activities including less than all of the sub-plurality of activities; and
returning the one or more activities to the client device.

2. The method of claim 1, wherein selecting one or more activities comprises selecting one of: an event, a deal, an advertisement, or a promotion relevant based on one or more of: the person's past behavior, past purchase patterns, and predicted future behavior.

3. The method of claim 1, wherein accessing user profile information comprises accessing interests for the person that were selected from a drill-down menu of different interests.

4. The method of claim 1, wherein the commerce partner is one of: a business, a personality, or a cause.

5. The method of claim 1, wherein selecting one or more activities from among the sub-plurality of activities as actually relevant to the person comprises selecting the one or more activities automatically to reduce the submission of further queries from the client device to a social media system that includes the computer system.

6. At a computer system, the computer system including a processor, a method for matching an item representing an activity to one or more person items representing a corresponding one or more persons, the method comprising a processor:
accessing user profile information for the plurality of persons, for each of the plurality of persons the user profile information including interests and a geographic location for the person;
accessing activity profile information for the activity, the activity profile information including a topic, a geographic location, and geo-location settings for the activity, the geo-location settings indicating a specified distance from the activity, the activity defined to be of interest to persons that are within the specified distance of the activity;
identifying a sub-plurality of persons from among the plurality of persons for which the activity is potentially relevant, for each person in the identified sub-plurality of persons the activity being potentially relevant to the person based on an interest in the person's user profile information;
selecting one or more persons from among the sub-plurality of persons for which the activity is actually relevant, the one or more persons being within the specified distance of the activity, the one or more persons including less than all of the sub-plurality of persons; and
storing an indication of the activity's actual relevance to the one or more persons in storage.

7. The method of claim 6, wherein the commerce partner is one of: a business, a personality, or a cause.

8. The method of claim 6, wherein accessing commerce partner profile information for the activity comprises accessing commerce partner profile information for one of: an event, a deal, an advertisement, or a promotion relevant.

9. The method of claim 6, wherein selecting one or more persons from among the sub-plurality of persons for which the activity is actually relevant comprises selecting one or more persons for which a deal, advertisement, or promo is actually relevant based on past behavior and predicted future behavior of one or more other persons.

10. The method of claim 6, further comprising:
subsequently receiving a query from a client device, the query requesting activities that are relevant to a person from among the selected one or persons;
returning the indication of the activity's actual relevance to the person from storage to the client device.

11. The method of claim 6, wherein storing an indication of the activity's actual relevance to the one or more persons in storage comprises caching the an indication of the activity's actual relevance to the one or more persons in system memory.

12. A computer program product for use at a computer system, the computer program product for implementing a method for matching an item representing a person to an item representing an activity, the computer program product comprising one or more computer storage devices having stored thereon computer-executable instructions that, when executed at a processor, cause the computer system to perform the method, including the following:
receive a query from a client device, the query requesting activities that are relevant to the person;
access user profile information for the person, the user profile information including interests, current geographic location, and geo-location settings for the person, the geo-location settings indicating a specified distance from the person, the person desiring to be made aware of activities of interest to the person that are within the specified distance of the person;
for each of a plurality of activities, access commerce partner profile information for the activity, the commerce partner profile information including a topic and a current geographic location for the activity from a corresponding commerce partner;
identify sub-plurality of activities from among the plurality of activities that are potentially relevant to the person based on the person's previously expressed interest in topics related to the sub-plurality of activities;
select one or more activities from among the sub-plurality of activities as actually relevant to the person based on the one or more activities being within the specified distance, the one or more activities including less than all of the sub-plurality of activities; and
return the one or more activities to the client device.

13. The computer program product of claim 12, wherein computer-executable instructions that, when executed at a processor, cause the computer system to select one or more activities comprise computer-executable instructions that, when executed at a processor, cause the computer system to select one of: an event, a deal, an advertisement, or a promotion relevant based on one or more of: the person's past behavior, past purchase patterns, and predicted future behavior.

14. The computer program product of claim 12, wherein computer-executable instructions that, when executed at a processor, cause the computer system to access user profile information comprise computer-executable instructions that, when executed at a processor, cause the computer system to access interests for the person that were selected from a drill-down menu of different interests.

15. The computer program product of claim 12, wherein the commerce partner is one of: a business, a personality, or a cause.

16. The computer program product of claim 12, wherein computer-executable instructions that, when executed at a processor, cause the computer system to select one or more activities from among the sub-plurality of activities as actually relevant to the person comprise computer-executable instructions that, when executed at a processor, cause the computer system to select the one or more activities automatically to reduce the submission of further queries from the client device to a social media system that includes the computer system.
